(19) United States
(12) Patent Application Publication
(10) Pub. No.: US 2019/0048938 A1
(43) Pub. Date: Feb. 14, 2019

(54) A WIND TURBINE COMPRISING A TORQUE TRANSMITTING COUPLING

(71) Applicant: Vestas Wind Systems A/S, Aarhus N. (DK)

(72) Inventors: Jens Demtröder, Rønde (DK); Adriana Verde Ríos, Aarhus C (DK)

(21) Appl. No.: 16/080,177

(22) PCT Filed: Feb. 16, 2017
(86) PCT No.: PCT/DK2017/050042

§ 371 Date: Aug. 27, 2018

(30) Foreign Application Priority Data
Mar. 1, 2016 (DK) PA 2016 70120

(51) Int. Cl. F16D 1/08; F16D 1/092; F03D 15/10; F03D 9/25

(52) U.S. Cl. CPC F16D 1/087; F16D 1/092; F05B 2240/60; F03D 9/25; F03D 15/10

(57) ABSTRACT

A wind turbine (101) comprising a torque transmitting coupling (1) between a first rotatable part (2, 3) and a second rotatable part (2, 3) of the wind turbine (101), e.g. in the form of a hub (2) and a shaft (3), is disclosed. The torque transmitting coupling (1) comprises a form- fitted coupling and a compression means (5, 8, 9, 12, 13). The form-fitted coupling defines a plurality of drive flanks formed on the first rotatable part (2, 3) and a plurality of driven flanks formed on the second rotatable part (2, 3). The compression means (5, 8, 9, 12, 13) is arranged on an internal or external perimeter of the form-fitted coupling, and the compression means (5, 8, 9, 12, 13) provides a frictional coupling between the first rotatable part (2, 3) and the second rotatable part (2, 3). The torque transmitting coupling (1) is capable of locking up to six degrees of freedom between the first rotatable part (2, 3) and the second rotatable part (2, 3), while allowing the first rotatable part (2, 3) and the second rotatable part (2, 3) to be easily dissembled.

### FIELD OF THE INVENTION

The present invention relates to a wind turbine comprising a torque transmitting coupling between a first rotatable part and a second rotatable part. The torque transmitting coupling is arranged to transfer torque from the first rotatable part to the second rotatable part and/or from the second rotatable part to the first rotatable part. The torque transmitting coupling of the invention is capable of locking up to six degrees of freedom between the first rotatable part and the second rotatable part, while allowing the first rotatable part and the second rotatable part to be easily dissembled.

### BACKGROUND OF THE INVENTION

Torque transmitting couplings for transmitting torque between two rotatable parts, such as a hub and a shaft of a wind turbine, are known. Such torque transmitting couplings are traditionally grouped into two groups, according to their principle of action, i.e. form-fitted couplings and frictional couplings.

Form-fitted couplings, such as keys, splines, serrations or polygon profiles, provide high torque transmitting capacity. However, form-fitted couplings do normally not lock other degrees of freedom with relevant load carrying capacity. Furthermore, a backlash may be introduced between the rotatable parts being interconnected by means of the torque transmitting coupling, allowing the two parts to move relative to each other, e.g. along tangential, axial and/or radial directions. Therefore, form-fitted coupling are particularly suitable for uni-directional torque loading.

Frictional couplings, such as cylindrical or conical shrink fits, transfer torque due to frictional engagement between the rotatable parts. Such torque transmitting couplings provide high torque transmitting capacity per diameter, can transfer torque in both directions, and also lock other degrees of freedom. However, frictional couplings are normally not easily dissembled. Furthermore, a certain level of solidity is required of the two rotatable parts in order to maintain a required contact pressure between the two rotatable parts without introducing plastic deformation of one or both of the rotatable parts, which increases material use, weight and cost.

Examples of frictional couplings include shrink discs or clamping sets, which are special forms of frictional couplings, where the friction force is temporarily applied by an additional machine element, which can be easily dissembled. The advantages and disadvantages described above with reference to cylindrical or conical shrink fits also apply here.

Thus, the form-fitted couplings and the frictional couplings each provide a number of advantages and a number of disadvantages. Accordingly, a torque transmitting coupling of a type which is best suited under the given circumstances is normally selected, and the disadvantages associated with the selected type of torque transmitting coupling are accepted.

WO 97/44598 discloses a shaft-hub connection, especially for a gear wheel on a transmission. The gear wheel, as well as being force-fitted, is prevented from making microscopic movements on the shaft by a pin-like interlocking bond.

### DESCRIPTION OF THE INVENTION

It is an object of embodiments of the invention to provide a torque transmitting coupling which is capable of locking six degrees of freedom between a first rotatable part and a second rotatable part, while allowing the first rotatable part and the second rotatable part to be easily dissembled.

The invention provides a wind turbine comprising a torque transmitting coupling between a first rotatable part and a second rotatable part of the wind turbine, the first rotatable part and the second rotatable part being arranged concentrically with respect to each other, the torque transmitting coupling comprising:
a form-fitted coupling defining a plurality of drive flanks formed on the first rotatable part and a plurality of driven flanks formed on the second rotatable part, the drive flanks being arranged in torque transmitting engagement with the driven flanks, and the drive flanks and the driven flanks extending substantially along a direction defined by an axis of rotation of the first and second rotatable parts, and
a compression means arranged on an internal or external perimeter of the form-fitted coupling, the compression means providing a frictional coupling between the first rotatable part and the second rotatable part.

Thus, the invention provides a wind turbine comprising a torque transmitting coupling between two rotatable parts of the wind turbine. The rotatable parts could, e.g., be in the form of a hub and a shaft. The torque transmitting coupling ensures that torque is transferred from the first rotatable part to the second rotatable part, or vice versa.

The first rotatable part and the second rotatable part are arranged concentrically with respect to each other, and may advantageously be arranged to rotate about the same axis of rotation. Thus, the first rotatable part is arranged along an outer circumferential part of the second rotatable part, or the second rotatable part is arranged along an outer circumferential part of the first rotatable part. In other words, the first rotatable part and the second rotatable part overlap in a region extending along an axial direction, i.e. a direction defined by the common axis of rotation.

The torque transmitting coupling comprises a form-fitted coupling and a compression means. The form-fitted coupling defines a plurality of drive flanks formed on the first rotatable part and a plurality of driven flanks formed on the second rotatable part. The drive flanks are arranged in torque transmitting engagement with the driven flanks. Thereby the drive flanks are capable of transmitting torque to the driven flanks when the first rotatable part rotates, thereby transmitting torque from the first rotatable part to the second rotatable part.

The drive flanks and the driven flanks extend substantially along a direction defined by an axis of rotation of the first and second rotatable parts. Accordingly, the drive flanks and the driven flanks extend along the region in which the first rotatable part and the second rotatable part overlap, i.e. the torque transfer provided by the form-fitted coupling takes place in this region.

The compression means is arranged on an internal or external perimeter of the form-fitted coupling, and the compression means provides a frictional coupling between the first rotatable part and the second rotatable part. Accordingly, the compression means is arranged in the overlapping region of the first rotatable part and the second rotatable part, and at the position of the drive flanks and the driven flanks of the form-fitted coupling. Thereby the compression means pushes the drive flanks and the driven flanks towards each other, thereby providing a frictional coupling between the first rotatable part and the second rotatable part at a position corresponding to the drive flanks and the driven flanks. This substantially eliminates any backlash of the form-fitted coupling, and essentially locks the remaining degrees of freedom, thereby removing the disadvantages of the form-fitted coupling, while maintaining the high capacity of this coupling for transmitting unidirectional torque.

Furthermore, since the frictional coupling is provided by means of a compression means, instead of by means of heat shrinking or the like, the frictional coupling can easily be dissembled without destroying any parts of the torque transmitting coupling.

The form-fitted coupling may advantageously be mainly responsible for the torque transmission taking place between the first rotatable part and the second rotatable part, at least along a main direction of torque transfer. For instance, the form-fitted coupling may be arranged to transmit at least 80% of the torque being transmitted between the first rotatable part and the second rotatable part. In this case, the frictional coupling provided by the compression means may only be responsible for transmitting a minor portion of the torque, and the primary purpose of the frictional coupling may be to lock the degrees of freedom which are not locked by the form-fitted coupling. However, in the case that the torque transmitting coupling is arranged to reverse the direction of the torque transfer, the form-fitted coupling may be arranged to transfer peak loads in the main direction, while the friction coupling may be arranged to transfer peak loads in the reverse direction. Thereby micro movements are prevented once the torque transmitting coupling has been aligned on the drive flanks and driven flanks.

The form-fitted coupling may define a plurality of lands formed on the first rotatable part and a plurality of opposing lands formed on the second rotatable part, and the compression means may be arranged to remove a clearance between the lands and the opposing lands, thereby providing the frictional coupling between the lands and the opposing lands.

In the present context the term ‘land’ should be interpreted to mean a portion of the first or second rotatable part which is arranged adjacent to a drive flank or a driven flank, and which faces the other rotatable part in a radial direction. For instance, in the case that the form-fitted coupling comprises mating sets of teeth formed on the first and second rotatable parts, respectively, the drive flanks and the driven flanks may be formed by side surfaces of the teeth, and the lands may be formed at the tops of the teeth or at the valleys formed between the teeth. Lands formed at the tops of the teeth may be referred to as ‘top lands’, and lands formed at the valleys formed between the teeth may be referred to as ‘bottom lands’. In the case that teeth are formed on an outer surface of a part, top lands may be formed at an addendum defined by the teeth, and bottom lands may be formed at a dedendum defined by the teeth.

Similarly, in the present context the term ‘opposing land’ should be interpreted to mean a land formed on the second rotatable part which opposes the lands formed on the first rotatable part. For instance, in the case that the lands formed on the first part are in the form of top lands, then the opposing lands formed on the second rotatable part will be bottom lands, and vice versa. Accordingly, the lands and the opposing lands are arranged opposite each other with a, possibly small, clearance there between.

According to this embodiment, the gap that needs to be bridged between the rotating parts by means of the compression means, in order to provide the frictional coupling, is relatively small. Thereby the strain introduced in the rotating parts due to the compression is relatively low. Furthermore, the tolerance requirements are not very critical, since the lands will normally form part of a cylindrical shape, e.g. defined by the addendum or the dedendum defined by the teeth.

In the case that the frictional coupling is provided between lands, as described above, torque transfer along a main direction of torque transfer may be primarily provided by means of the form-fitted coupling, while torque transfer along a reverse direction may be primarily provided by the frictional coupling between the lands.

The lands may be in the form of top lands or in the form of bottom lands. As described above, in the case that the lands are in the form of top lands, the opposing lands may advantageously be in the form of bottom lands, and in the case that the lands are in the form of bottom lands, the opposing lands may advantageously be in the form of top lands. Thus, according to this embodiment, the compression means is arranged to remove a clearance between top lands formed on one of the first or second rotatable parts and bottom lands formed on the other of the first or second rotatable parts.

The form-fitted coupling may comprise a first set of teeth formed on the first rotatable part and a second set of teeth formed on the second rotatable part, the first set of teeth defining the drive flanks and the second set of teeth defining the driven flanks.

According to this embodiment, the form-fitted coupling is provided by mating sets of teeth, e.g. gear teeth, formed on the first rotatable part and the second rotatable part, respectively, the mating sets of teeth being arranged in engagement with each other.

The form-fitted coupling may be or comprise a spline. For instance, the spline may be in the form of an involute spline, a straight-sided spline, a serrated spline, or any other suitable kind of spline. Involute splines and straight-sided splines are suitable for combination with friction fit on the top land of the teeth of the male part (sometimes referred to as ‘major diameter fit’) or the top land of the teeth on the female part (sometimes referred to as ‘minor diameter fit’). Involute splines and serrated splines may be combined with a friction fit acting equally on both tooth flanks (sometimes referred to as ‘flank centred fit’). This solution may be advantageous for applications where a peak torque in both directions reach similar amplitude and frequency. More complex spline profiles, for instance profiles with essentially circular flanks, may be applied. Examples of such profiles include Novikov profiles or troichoidal profiles.

As an alternative, other kinds of form-fitted couplings may be applied, such as serrations or polygon profiles, etc.

The drive flanks may form an integral part of the first rotatable part and/or the driven flanks may form an integral part of the second rotatable part. According to this embodiment the drive flanks and/or the driven flanks are formed directly in the first and/or second rotatable part. For instance, the drive flanks and/or driven flanks may be machined directly into the relevant rotatable part.

As an alternative, the drive flanks and/or the driven flanks may be formed on a separate part, which is subsequently mounted on or attached to the first rotatable part and/or the second rotatable part.

The compression means may comprise at least one conical surface, and the compression means may be arranged to provide compression by dislocating at least one part having a conical surface formed thereon.

According to this embodiment, the compression is provided by dislocating a conical surface, e.g. along an axial direction. The conical shape provides a wedge effect, which pushes the first rotatable part and the second rotatable part towards each other, along a direction being substantially perpendicular to the direction of dislocation, i.e. preferably along a substantially radial direction. The conical surface being dislocated may be moved against another conical surface formed on another part. Alternatively, the conical surface may be moved against a flange or the like. At least one part may be provided with two conical surfaces, in which case two separate parts may be dislocated relative to the part having the two conical surfaces formed thereon, along substantially opposite axial directions.

At least one conical surface may form an integral part of the first rotatable part and/or at least one conical surface may form an integral part of the second rotatable part.

As an alternative, the compression means may be or comprise another type of shrink disc or a clamping element.

The first rotatable part or the second rotatable part may be a hub, and the second rotatable part or the first rotatable part may be a shaft. For instance, the hub may be a rotor hub of the wind turbine, carrying the wind turbine blades, and the shaft may be main shaft of the wind turbine. Alternatively, the rotatable parts may be any other suitable kinds of rotatable parts of the wind turbine, which require torque transfer there between, for instance a main shaft and a part of a gear box, such as a planet carrier, respectively, a gear wheel and a shaft, respectively, or magnetically active parts of a generator and a generator shaft, respectively.

The frictional coupling may be resolvable. Thereby the frictional coupling can be dissembled without destroying any parts of the torque transmitting coupling. This may, e.g., be obtained by providing a compression means which can be removed from the torque transmitting coupling. One example of such a resolvable frictional coupling is provided by the compression means comprising a conical surface, as described above.

The drive flanks and the driven flanks may be arranged on mating conical parts of the first rotatable part and the second rotatable part. For instance, in the case that the form-fitted coupling comprises mating sets of teeth formed on the first rotatable part and the second rotatable part, respectively, the landings of the teeth may define surfaces which incline along the direction defined by the axis of rotation. The mating conical parts ensure that the first rotatable part and the second rotatable part can be easily arranged adjacent to each other, with the drive flanks and the driven flanks arranged in the overlapping region, by moving the rotatable parts relative to each other along the direction defined by the axis of rotation.

Initially, a relatively large clearing is defined between the first rotatable part and the second rotatable part, but this clearing decreases as a function of the relative axial movement of the first rotatable part and the second rotatable part. Thereby the compression means will only need to provide the friction coupling, since the clearance between the first rotatable part and the second rotatable part has already been eliminated.

It should be noted that the embodiment described above could also be applied in combination with other kinds of torque transmitting couplings, such as couplings in which a frictional coupling is provided in other ways than by means of a compression means, e.g. by means of a shrink fit or another kind of non-resolvable friction coupling.

### BRIEF DESCRIPTION OF THE DRAWINGS

The invention will now be described in further detail with reference to the accompanying drawings in which

FIG. 1 is a perspective view of a torque transmitting coupling for use in a wind turbine according to a first embodiment of the invention,

FIG. 2 is a perspective view of a torque transmitting coupling for use in a wind turbine according to a second embodiment of the invention,

FIG. 3 is a perspective view of a torque transmitting coupling for use in a wind turbine according to a third embodiment of the invention,

FIG. 4 is a perspective view of a torque transmitting coupling for use in a wind turbine according to a fourth embodiment of the invention,

FIGS. 5 and 6 illustrate an exemplary wind turbine according to an embodiment of the invention, and

FIG. 7 is a perspective view of a part of a rotatable part comprising a set of teeth forming part of a torque transmitting coupling for use in a wind turbine according to an embodiment of the invention.

### DETAILED DESCRIPTION OF THE DRAWINGS

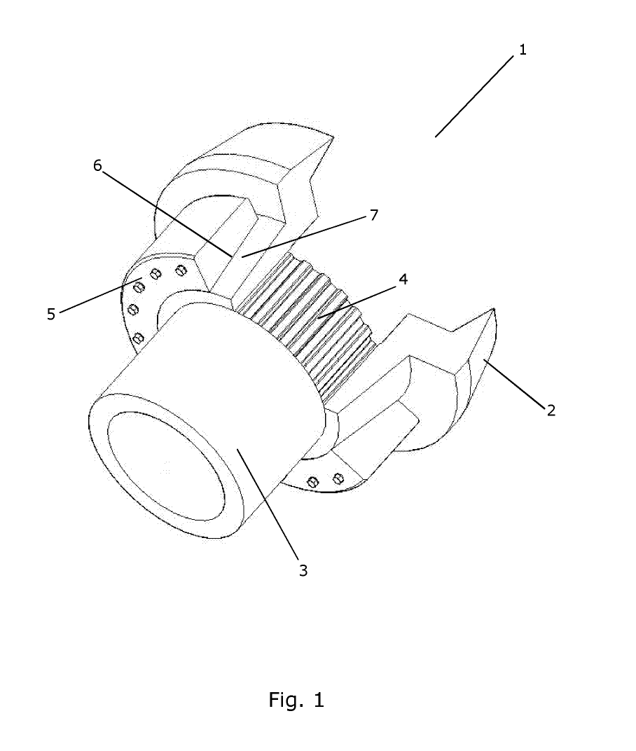

FIG. 1 is a perspective view of a torque transmitting coupling 1 for use in a wind turbine according to a first embodiment of the invention. Parts of the torque transmitting coupling 1 have been broken away in order to reveal interior parts of the torque transmitting coupling 1.

The torque transmitting coupling 1 comprises a first rotatable part in the form of a hub 2 and a second rotatable part in the form of a shaft 3. The hub 2 and the shaft 3 are arranged concentrically with respect to each other in such a manner that a part of the hub 2 is arranged along an exterior part of the shaft 3. Thereby an overlapping region between the hub 2 and the shaft 3 is defined, and the hub 2 and the shaft 3 are arranged to rotate about a common axis of rotation. In the overlapping region, the hub 2 is provided with a set of teeth (not visible) at an inner perimeter facing the shaft 3. Furthermore, the shaft 3 is provided with a set of teeth 4 at an outer perimeter facing the hub 2. Thereby the teeth formed on the hub 2 and the teeth 4 formed on the shaft 3 are arranged in torque transmitting engagement, thereby forming a form-fitted coupling between the hub 2 and the shaft 3.

The torque transmitting coupling 1 further comprises a compression means in the form of a clamping ring 5 arranged on an external perimeter of the form-fitted coupling, i.e. in a position corresponding to the overlapping region of the hub 2 and the shaft 3. The clamping ring 5 is provided with a conical inner surface 6 which is arranged in contact with a conical outer surface 7 formed on the hub 2. The clamping ring 5 can be mounted onto the hub 2 by displacing it along an axial direction defined by the common axis of rotation of the hub 2 and the shaft 3. In the embodiment shown in FIG. 1, the displacing motion is performed by means of bolts. However, the displacing motion may, alternatively, be performed by means of hydraulics or tools, or in other suitable ways.

As the clamping ring 5 is displaced axially as described above, the conical surfaces 6, 7 cause the clamping ring 5 to contract the hub 2, thereby pressing the hub 2 towards the shaft 3 in the overlapping region, i.e. in the region where the form-fitted coupling between the hub 2 and the shaft 3 is formed. Thereby a compression stress is created which bridges any geometric clearance between the teeth formed on the hub 2 and the teeth 4 formed on the shaft 3. As a consequence, the top lands of the teeth 4 formed on the shaft 3 make contact in the root of the teeth formed on the hub 2, and the top lands will be allowed to transfer forces by means of friction. Accordingly, the clamping ring 5 provides a frictional coupling between the hub 2 and the shaft 3.

The frictional coupling provided by the clamping ring 5, as described above, ensures that any backlash of the form-fitted coupling is essentially eliminated, and essentially locks the degrees of freedom which are not locked by the form-fitted coupling. Furthermore, since the frictional coupling is provided by the clamping ring 5 being slided onto the hub 2, the frictional coupling can easily be dissembled without destroying any parts of the torque transmitting coupling 1.

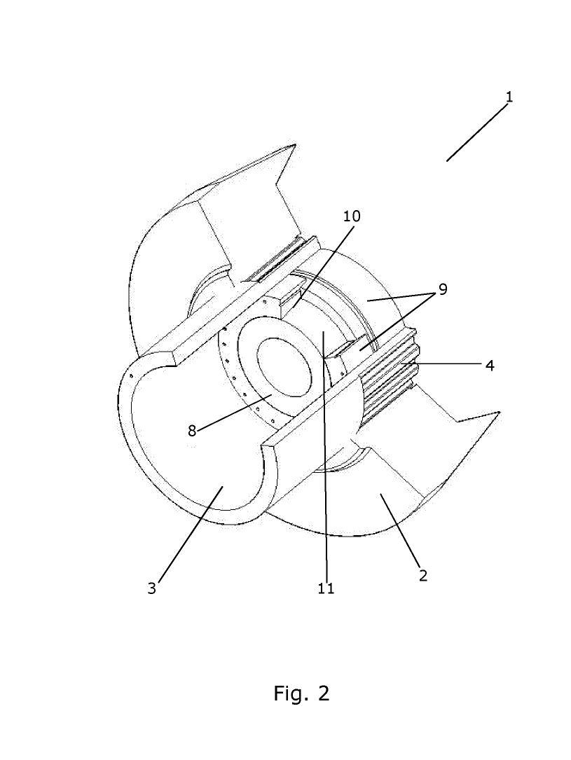

FIG. 2 is a perspective view of a torque transmitting coupling 1 for use in a wind turbine according to a second embodiment of the invention. Parts of the torque transmitting coupling 1 have been broken away in order to reveal interior parts of the torque transmitting coupling 1.

The torque transmitting coupling 1 of FIG. 2 is similar to the torque transmitting coupling 1 of FIG. 1 in the sense that it comprises a hub 2 and a shaft 3 arranged concentrically with respect to each other, thereby forming an overlapping region in which a set of teeth (not shown) formed on the hub 2 and a set of teeth 4 formed on the shaft 3 are arranged in torque transmitting engagement, thereby forming a form-fitted coupling between the hub 2 and the shaft 3.

The hub 2 of the torque transmitting coupling 1 of FIG. 2 has a relatively large diameter in the overlapping region, and therefore an external clamping ring, as illustrated in FIG. 1, is not suitable for providing the frictional coupling. But it provides a large moment of resistance for maintaining a contact pressure. Instead the torque transmitting coupling 1 of FIG. 2 comprises a compression means in the form of a double conical inner support ring 8 and two outer rings 9, each being provided with an inner conical surface 10 arranged in contact with an outer conical surface 11 of the double conical inner support ring 8. The compression means is arranged in a position corresponding to the position of the overlapping region defined by the hub 2 and the shaft 3, i.e. in the region of the form-fitted coupling between the hub 2 and the shaft 3.

The outer rings 9 are arranged to be displaced axially, in opposite directions. Similarly to the embodiment illustrated in FIG. 1, the outer rings 9 thereby push the shaft 3 outwards and towards the hub 2, and bridging any geometrical clearance between the teeth formed on the hub 2 and the teeth 4 formed on the shaft 3. Accordingly, a friction coupling between the hub 2 and the shaft 3 is formed by means of the compression means 8, 9, and the advantages described above with reference to FIG. 1 are obtained.

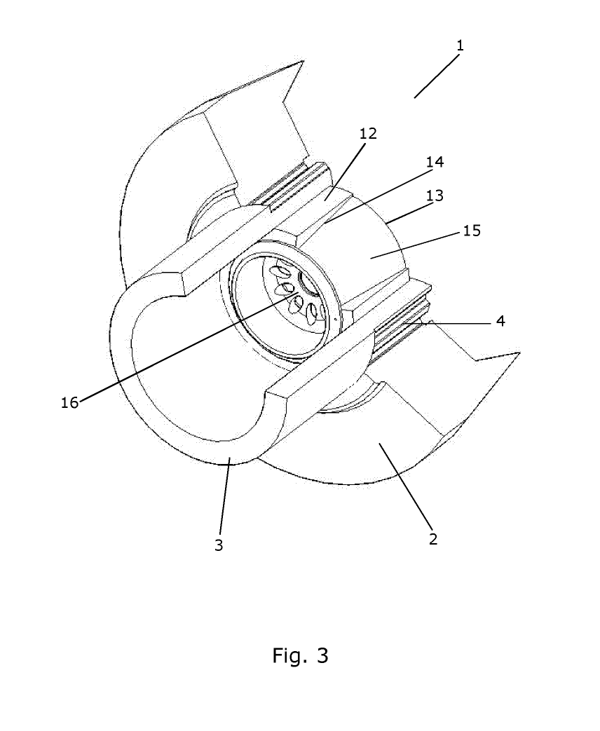

FIG. 3 is a perspective view of a torque transmitting coupling 1 for use in a wind turbine according to a third embodiment of the invention. Parts of the torque transmitting coupling 1 have been broken away in order to reveal interior parts of the torque transmitting coupling 1.

The torque transmitting coupling 1 of FIG. 3 is very similar to the torque transmitting coupling 1 of FIG. 2 in that it also comprises a compression means arranged on an internal perimeter of the overlapping region, and thereby of the form-fitted coupling formed between the hub 2 and the shaft 3. In the torque transmitting coupling 1 of FIG. 3 the compression means is in the form of an insert ring 12 arranged along an inner perimeter of the hub 2 and a clamping device 13 arranged along an inner perimeter of the insert ring 12.

The insert ring 12 is provided with an inner conical surface 14, and the clamping device 13 is provided with an outer conical surface 15, the conical surfaces 14, 15 being arranged in contact with each other. Accordingly, a frictional coupling can be provided between the hub 2 and the shaft 3 by displacing the clamping device 13 axially, similarly to the situation described above with reference to FIG. 2.

The clamping device 13 is provided with a web 16 with a high moment of resistance. The web 16 prevents the shaft 3 from contraction when the clamping device 13 is displaced axially in order to provide the frictional coupling between the hub 2 and the shaft 3.

It should be noted that even though the insert ring 12 is shown as a separate part in FIG. 3, it could also be envisaged that the inner conical surface 14 provided by the insert ring 12 could be formed directly on the inner perimeter of the shaft 3.

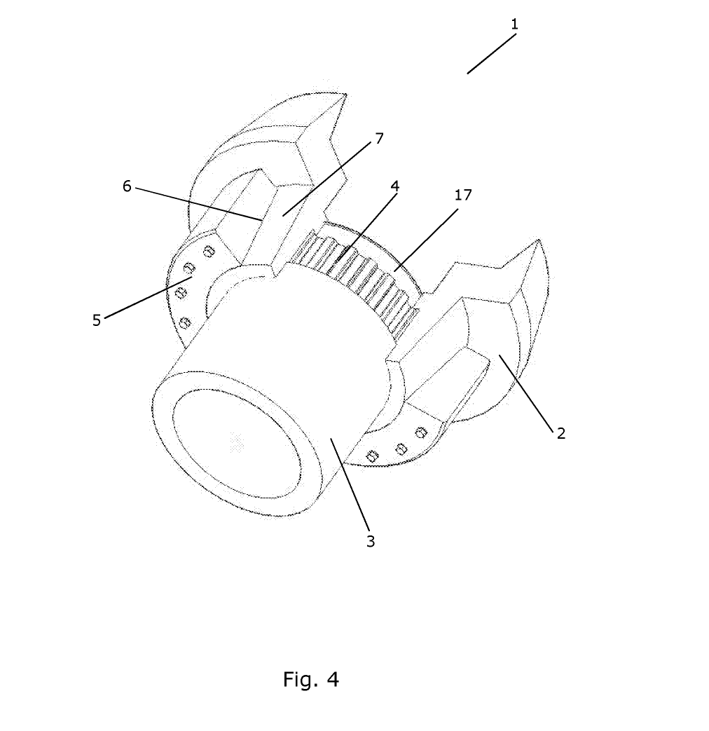

FIG. 4 is a perspective view of a torque transmitting coupling 1 for use in a wind turbine according to a fourth embodiment of the invention. Parts of the torque transmitting coupling 1 have been broken away in order to reveal interior parts of the torque transmitting coupling 1.

The torque transmitting coupling 1 of FIG. 4 is very similar to the torque transmitting coupling 1 of FIG. 1, and it will therefore not be described in detail here. In the torque transmitting coupling 1 of FIG. 4 a pilot diameter 17 is provided in the overlapping region at a position adjacent to the teeth formed on the hub 2 and the teeth 4 formed on the shaft 3. This is particularly advantageous in the case that transverse forces and moments acting on the hub 2 and the shaft 3 are large compared to the torque being transferred between the hub 2 and the shaft 3. The friction coupling provided by the clamping ring 5 acts on the pilot diameter 17 as well as on the form-fitted coupling defined by the engaged teeth 4.

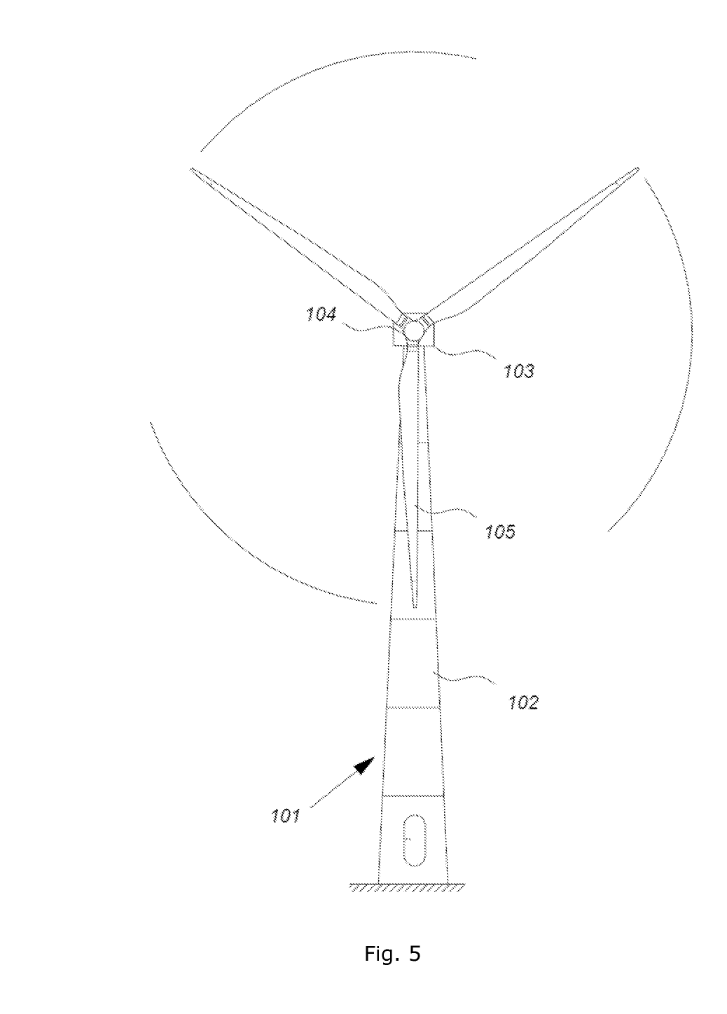

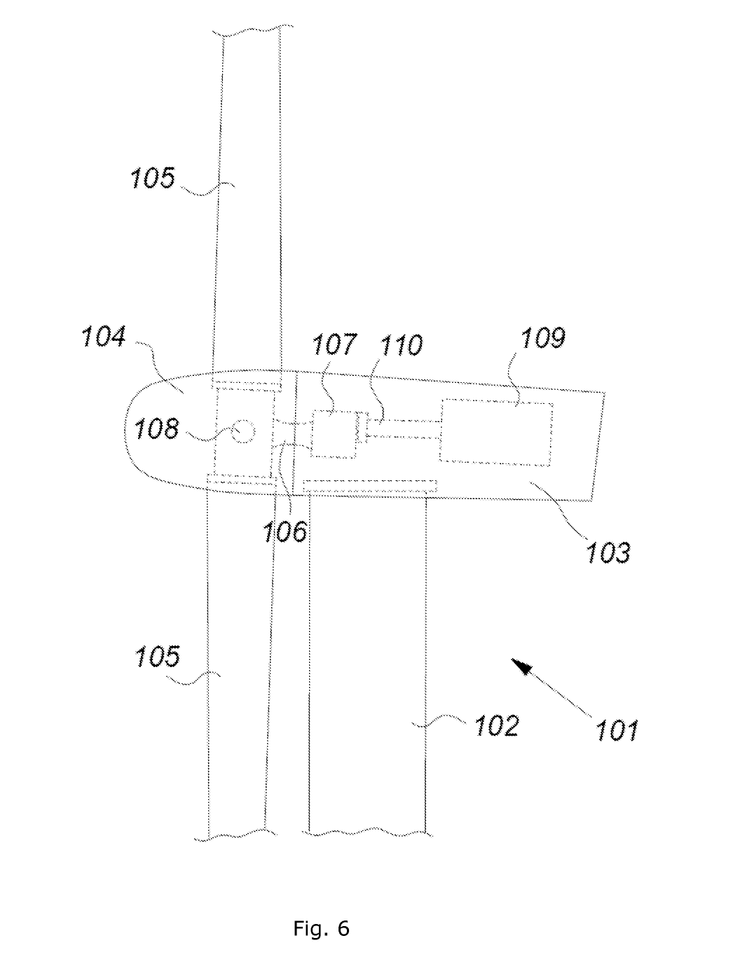

Reference will now be made to FIGS. 5 and 6 to illustrate an exemplary wind turbine 101 for implementation of the torque transmitting coupling as described herein. FIG. 5 illustrates a wind turbine 101, comprising a tower 102 and a wind turbine nacelle 103 positioned on top of the tower 102. The wind turbine rotor 104, comprising three wind turbine blades 105, is connected to the nacelle 103 through the low speed shaft 6 which extends out of the nacelle 103 front.

FIG. 6 illustrates an embodiment of a wind turbine nacelle 103, as seen from the side. The drive train in a traditional wind turbine 101 known in the art usually comprises a rotor 104 connected to a gearbox 107 by means of a low speed shaft 106. In this embodiment the rotor 104 comprise only two blades 105 connected to the low speed shaft 106 by means of a teeter mechanism 108, but in another embodiment the rotor 104 could comprise another number of blades 105, such as three blades 105, which is the most common number of blades 105 on modern wind turbines 101. In another embodiment the rotor 104 could also be connected directly to the gearbox 107.

The gearbox 107 is then connected to the generator 109 by means of a high speed shaft 110.

Because of the limited space in the nacelle 103 and in order to minimize the weight of the nacelle 103 the preferred gearbox 107 type in most modern wind turbines 101 is an epicyclical gearbox, but other gearbox types are also feasible, such as one or more spur gearboxes, worm gearboxes, helical gearboxes or a combination of different transmission and gearbox 107 types.

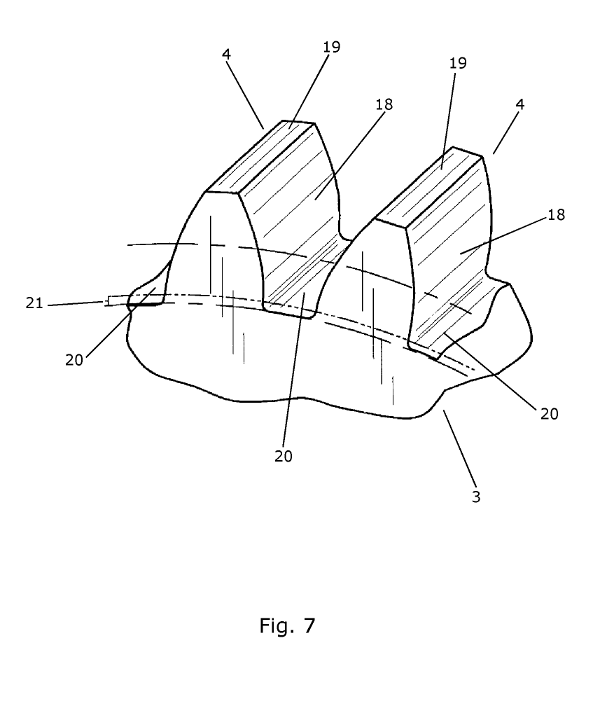

FIG. 7 is a perspective view of a part of a rotatable part 3 comprising a set of teeth 4, two of which are shown. The teeth 4 are formed on an outer surface of the rotatable part 3, and form part of a torque transmitting coupling for use in a wind turbine according to an embodiment of the invention. The teeth 4 are adapted to engage mating teeth formed on an inner surface of another rotatable part, e.g. as described above with reference to any of FIGS. 1-4.

Each tooth 4 defines a drive flank 18 arranged to engage a driven flank of a tooth of another rotatable part, thereby forming a form-fitted coupling. Furthermore, each tooth 4 defines a top land 19 on a part of the tooth 4 which faces the other rotatable part. Bottom lands 20 are defined between the teeth 4. The surfaces of the top lands 19 follow an addendum circle of the teeth 4, and the surfaces of the bottom lands 20 follow a dedendum circle.

When the rotatable part 3 is arranged adjacent to another rotatable part, essentially in the manner described above with reference to any of FIGS. 1-4, the top lands 19 will be positioned opposite bottom lands formed between the teeth of the other rotatable part, and the bottom lands 20 will be positioned opposite top lands formed on the teeth of the other rotatable part, with a clearance between oppositely positioned lands 19, 20. The clearance 21 between the bottom lands 20 and the top lands of the other rotatable part is indicated in FIG. 7.

When compression means is subsequently arranged on an internal or external perimeter of the form-fitted coupling, the oppositely positioned lands 19, 20 are pushed towards each other. For instance, the bottom lands 20 of the rotatable part 3 and the oppositely positioned top lands of the other rotatable part may be pushed towards each other until the clearance 21 between the bottom lands 20 and the top lands is removed. Thereby a frictional coupling is provided between the bottom lands 20 and the top lands of the other rotatable part.

As an alternative, the top lands 19 of the rotatable part 3 and the bottom lands of the other rotatable part may be pushed towards each other until the clearance between the top lands 19 and the bottom lands is removed, thereby providing a frictional coupling between the top lands 19 and the bottom lands of the other rotatable part.

As another alternative, the clearance between the top lands 19 of the rotatable part 3 and the bottom lands of the other rotatable part, as well as the clearance 21 between the bottom lands 20 and the top lands of the other rotatable part may be removed.

In any event, the gap between the rotatable part 3 and the other rotatable part which needs to be bridged by the compression means, in order to provide the frictional coupling, is relatively small. Furthermore, since the lands 19, 20 form part of a cylindrical shape, the tolerance requirements are not critical.

The invention has been exemplified above with reference to specific examples. However, it should be understood that the invention is not limited to the particular examples described above but may be designed and altered in a multitude of varieties within the scope of the invention as specified in the claims.

1. A wind turbine comprising a torque transmitting coupling between a first rotatable part and a second rotatable part of the wind turbine, the first rotatable part and the second rotatable part being arranged concentrically with respect to each other, the torque transmitting coupling comprising:
form-fitted coupling defining a plurality of drive flanks formed on the first rotatable part and a plurality of driven flanks formed on the second rotatable part, the drive flanks being arranged in torque transmitting engagement with the driven flanks, and the drive flanks and the driven flanks extending substantially along a direction defined by an axis of rotation of the first and second rotatable parts, and
a compression means arranged on an internal or external perimeter of the form-fitted coupling, the compression means providing a frictional coupling between the first rotatable part and the second rotatable part.

2. The wind turbine according to claim 1, wherein the form-fitted coupling defines a plurality of lands formed on the first rotatable part and a plurality of opposing lands formed on the second rotatable part, and wherein the compression means is arranged to remove a clearance between the lands and the opposing lands, thereby providing the frictional coupling between the lands and the opposing lands.

3. The wind turbine according to claim 2, wherein the lands are in the form of top lands or in the form of bottom lands.

4. The wind turbine according to claim 1, wherein the form-fitted coupling comprises a first set of teeth formed on the first rotatable part and a second set of teeth formed on the second rotatable part, the first set of teeth defining the drive flanks and the second set of teeth defining the driven flanks.

5. The wind turbine according to claim 1, a wherein the form-fitted coupling is or comprises a spline.

6. The wind turbine according to claim 1, wherein the drive flanks form an integral part of the first rotatable part and/or the driven flanks form an integral part of the second rotatable part.

7. The wind turbine according to claim 1, wherein the compression means comprises at least one conical surface, and wherein the compression means is arranged to provide compression by dislocating at least one part having a conical surface formed thereon.

8. The wind turbine according to claim 7, wherein at least one conical surface forms an integral part of the first rotatable part and/or at least one conical surface forms an integral part of the second rotatable part.

9. The wind turbine according to claim 1, wherein the first rotatable part or the second rotatable part is a hub, and the second rotatable part or the first rotatable part is a shaft.

10. The wind turbine according to claim 1, wherein the frictional coupling is resolvable.

11. The wind turbine according to claim 1, wherein the drive flanks and the driven flanks are arranged on mating conical parts of the first rotatable part and the second rotatable part.
